(19) United States
(12) Patent Application Publication
(10) Pub. No.: US 2019/0187728 A1
(43) Pub. Date: Jun. 20, 2019

(54) AUTOMATIC FOLLOWING APPARATUS AND AUTOMATIC FOLLOWING SYSTEM

(71) Applicant: Hua-chuang Automobile Information Technical Center Co., Ltd., New Taipei City (TW)

(72) Inventors: Ming-Fong Tsai, New Taipei City (TW); Chih-Sheng Li, New Taipei City (TW); Chia-Yuan Lin, New Taipei City (TW); Chih-Ming Lin, New Taipei City (TW); Chung-Yuan Chang, New Taipei City (TW)

(21) Appl. No.: 15/963,801

(22) Filed: Apr. 26, 2018

(30) Foreign Application Priority Data
Dec. 18, 2017 (CN) 201711368889.9

(51) Int. Cl. G05D 1/12; G05D 1/02; G01C 21/08; G08G 1/00

(52) U.S. Cl. CPC G05D 1/12; G05D 1/0212; G08G 1/22; G05D 1/0259; G01C 21/08; G05D 1/027

(57) ABSTRACT

An automatic following system includes a target apparatus and a following apparatus. The target apparatus includes a first magnetometer, a first processing unit, and a first wireless communications unit. The first magnetometer keeps transmitting geomagnetic azimuth information. The first processing unit receives the geomagnetic azimuth information and outputs first direction angle information. The first wireless communications unit transmits a wireless signal comprising the first direction angle information. The following apparatus includes a second magnetometer, a second processing unit, a second wireless communications unit, and a control unit. The second magnetometer keeps transmitting the geomagnetic azimuth information. The second wireless communications unit receives the wireless signal. The second processing unit generates second direction angle information, and calculates following steering angle information according to the first direction angle information and the second direction angle information. The control unit controls the following apparatus to steerably advance according to the following steering angle information.

### CROSS-REFERENCE TO RELATED APPLICATION

This non-provisional application claims priority under 35 U.S.C. § 119(a) to Patent Application No. 201711368889.9 filed in China, P.R.C. on Dec. 18, 2017, the entire contents of which are hereby incorporated by reference.

### BACKGROUND

### Technical Field

The present disclosure relates to a mobile apparatus, and in particular, to an automatic following apparatus and an automatic following system.

### Related Art

As information networks flourish, hardware devices in people's life can be remotely controlled by using a network. For example, various hardware can be connected to the Internet for information exchange and communication by using an information sensor device (for example, a wireless sensor node, a radio frequency (RF) identification apparatus, or an infrared sensor) according to a protocol agreed in advance, thereby implementing remote control and management.

However, in the current high-tech society, many things still need to be done manually. For example, when shopping in a store, people have to push a cart with their hands. For another example, when needing to follow other vehicles during driving, people have to control a steering wheel, also with their hands, to control the movement of their own vehicles. For still another example, people have to drag a suitcase by themselves when travelling abroad.

### SUMMARY

In view of this, in an embodiment, an automatic following system is provided, including a target apparatus and a following apparatus. The target apparatus includes a first magnetometer, a first processing unit, and a first wireless communications unit. The first magnetometer keeps transmitting geomagnetic azimuth information. The first processing unit is connected to the first magnetometer and the first wireless communications unit. The first processing unit receives the geomagnetic azimuth information and outputs first direction angle information. The first direction angle information is an angle between a current advancing direction of the target apparatus and the Geomagnetic axis. The first wireless communications unit transmits a wireless signal comprising the first direction angle information. The following apparatus includes a second magnetometer, a second processing unit, a second wireless communications unit, and a control unit. The second magnetometer keeps transmitting the geomagnetic azimuth information. The second wireless communications unit is communicatively connected to the first wireless communications unit and receives the wireless signal. The second processing unit is connected to the second magnetometer and the second wireless communications unit. The second processing unit receives the geomagnetic azimuth information and generates second direction angle information. The second direction angle information is an angle between the following apparatus and the Geomagnetic axis, and the second processing unit calculates following steering angle information according to the first direction angle information and the second direction angle information. The control unit is connected to the second processing unit, and the control unit receives the following steering angle information and controls, according to the following steering angle information, the following apparatus to steerably advance.

In an embodiment, an automatic following apparatus is provided, including a magnetometer, a wireless communications unit, a processing unit, and a control unit. The magnetometer keeps transmitting geomagnetic azimuth information. The wireless communications unit keeps receiving an external wireless signal, where the external wireless signal includes first direction angle information. The processing unit is connected to the magnetometer and the wireless communications unit. The processing unit keeps receiving the geomagnetic azimuth information and generates second direction angle information according to the geomagnetic azimuth information. The second direction angle information is an angle between the automatic following apparatus and the Geomagnetic axis. The processing unit calculates following steering angle information according to the first direction angle information and the second direction angle information. The control unit is connected to the processing unit, and the control unit receives the following steering angle information and controls, according to the following steering angle information, the automatic following apparatus to steerably advance.

Based on the above, in the automatic following system and the automatic following apparatus in the embodiments of the present disclosure, the geomagnetic azimuth information of the Earth is measured by using the magnetometer, and a advancing azimuth of the target apparatus is obtained according to the geomagnetic azimuth information. Because the azimuth includes information about angle and direction, the following apparatus can calculate, according to the geomagnetic azimuth information and the advancing azimuth of the target apparatus, the steering angle of following the target apparatus, so that the following apparatus steerably advances according to the steering angle and implements automatic following.

### BRIEF DESCRIPTION OF THE DRAWINGS

FIG. 1 is a block diagram of an embodiment of an automatic following system;

FIG. 2 is a partial three-dimensional view of an embodiment of a following apparatus;

FIG. 3 is a schematic diagram showing following of an embodiment of an automatic following system;

FIG. 4 is a schematic diagram showing application of an embodiment of an automatic following system;

FIG. 5 is a schematic diagram showing application of another embodiment of an automatic following system;

FIG. 6 is a block diagram of another embodiment of a following apparatus; and

FIG. 7 is a schematic diagram showing steering correction of an embodiment of an automatic following system.

### DETAILED DESCRIPTION

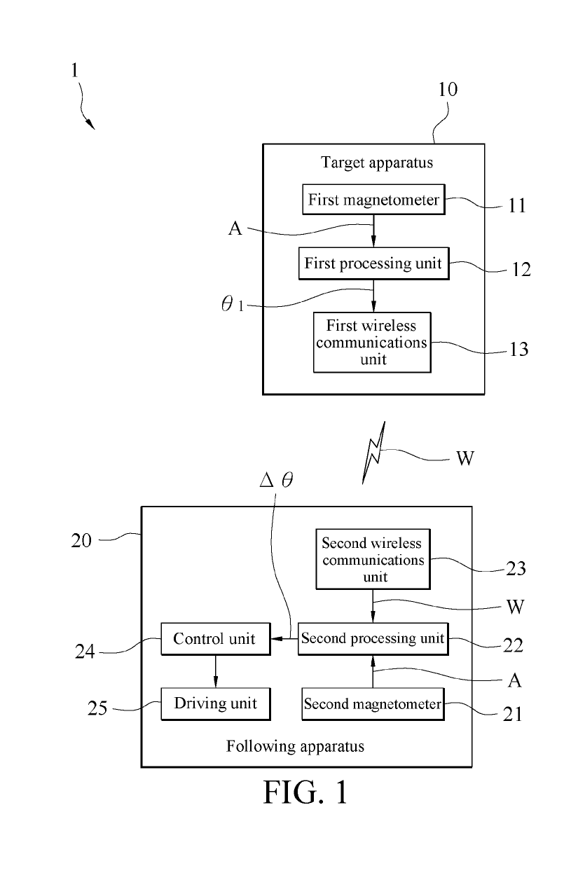

FIG. 1 is a block diagram of an embodiment of an automatic following system according to the present disclosure. In this embodiment, the automatic following system 1 includes a target apparatus 10 and a following apparatus 20. In some embodiments, the target apparatus 10 is a movable apparatus. For example, the target apparatus 10 may be an apparatus capable of automatic moving, such as an automatic aircraft, a self-propelled vehicle, or a self-propelled machine. Alternatively, the target apparatus 10 may be an apparatus capable of moving when manually controlled, such as a remote control plane, an automobile, or a bicycle. Further, alternatively, the target apparatus 10 may be a wearable apparatus or a portable apparatus capable of moving along with the movement of a human body, such as a watch, a hand ring, a mobile phone, a tablet computer, a backpack, or clothes.

In the embodiment of FIG. 1, the target apparatus 10 includes a first magnetometer 11, a first processing unit 12, and a first wireless communications unit 13. The first magnetometer 11 can keep transmitting geomagnetic azimuth information A. For example, the first magnetometer 11 may be specifically a micro magnetometer, which is also referred to as an electronic compass (E compass), and is mainly used for measuring a magnetic field azimuth of the North Pole of the Earth, to obtain the geomagnetic azimuth information A. For example, the first magnetometer 11 may obtain, by means of measurement, the geomagnetic azimuth information A by using the Hall effect or the magnetoresistance effect of a magnetic material. In an embodiment, the first magnetometer 11 may be designed into a three-axis magnetometer or a planar magnetometer according to an actual requirement.

As shown in FIG. 1, the first processing unit 12 in the target apparatus 10 is connected to the first magnetometer 11 and the first wireless communications unit 13. In some embodiments, the first processing unit 12 may be hardware capable of computing, such as a central processing unit (CPU), a programmable microprocessor, a digital signal processor (DSP), a programmable controller, an application-specific integrated circuit (ASIC), a programmable logic device (PLD), or another similar apparatus. The first processing unit 12 can receive the geomagnetic azimuth information A transmitted by the first magnetometer 11 and output first direction angle information θ₁. The first direction angle information θ₁ is an angle between a current advancing direction of the target apparatus 10 and the Geomagnetic axis. For example, assuming that the first magnetometer 11 detects that a geomagnetic azimuth shown in the geomagnetic azimuth information A (that is, an azimuth of the North Geomagnetic Pole) is 0°, the first processing unit 12 can calculate an angle (for example, 20°, 30°, or 50°) between the current advancing direction of the target apparatus 10 and the North Geomagnetic Pole. In this embodiment and the following embodiments, the North Geomagnetic Pole is used as reference of angle measurement.

Further, as shown in FIG. 1, the first wireless communications unit 13 can wirelessly transmit a wireless signal W comprising the foregoing first direction angle information θ₁. The first wireless communications unit 13 may be specifically an antenna unit, a WiFi unit, a 3G/4G unit, or an RF unit, to wirelessly transmit a signal to the outside.

In an embodiment, each element (the first magnetometer 11, the first processing unit 12, and the first wireless communications unit 13) in the target apparatus 10 may be separately disposed. For example, the first magnetometer 11, the first processing unit 12, and the first wireless communications unit 13 are independent elements and are separately disposed in the target apparatus 10. Alternatively, the elements in the target apparatus 10 may be disposed in a combined manner. For example, the first magnetometer 11, the first processing unit 12, and the first wireless communications unit 13 are integrated on a same circuit board and disposed in the target apparatus 10.

As shown in FIG. 1, in an embodiment, the following apparatus 20 is a movable apparatus. For example, the following apparatus 20 may be an apparatus that has a driving element (for example, a wheel or a rotor wing) and that can be actuated, such as an aircraft, an automobile, a suitcase, a cart, or a model vehicle. In the embodiment of FIG. 1, the following apparatus 20 includes a second magnetometer 21, a second processing unit 22, a second wireless communications unit 23, and a control unit 24.

As shown in FIG. 1, the second magnetometer 21 in the following apparatus 20 may also be an E compass for measuring the magnetic azimuth of the North Pole of the Earth, to obtain and transmit the geomagnetic azimuth information A. The second wireless communications unit 23 is communicatively connected to the first wireless communications unit 13. For example, the second wireless communications unit 23 may be specifically an antenna unit, a WiFi unit, a 3G/4G unit, or an RF unit, to wirelessly receive the wireless signal W transmitted by the first wireless communications unit 13.

As shown in FIG. 1, the second processing unit 22 in the following apparatus 20 is connected to the second magnetometer 21 and the second wireless communications unit 23. The second processing unit 22 may be hardware capable of computing, such as a CPU, a programmable microprocessor, a DSP, a programmable controller, an ASIC, a PLD, or another similar apparatus. The second processing unit 22 receives the geomagnetic azimuth information A and generates second direction angle information θ₂. The second direction angle information θ₂ is a direction angle of the following apparatus 20 relative to the North Geomagnetic Pole. For example, assuming that the second magnetometer 21 detects that a geomagnetic azimuth shown in the geomagnetic azimuth information A (that is, an azimuth of the North Geomagnetic Pole) is 0°, the second processing unit 22 can calculate an angle (for example, 20°, 30°, or 50°) between a current facing direction or advancing direction of the following apparatus 20 and the North Geomagnetic Pole.

In addition, the second processing unit 22 in the following apparatus 20 can calculate following steering angle information Δθ according to the first direction angle information θ₁ and the second direction angle information θ₂. The control unit 24 of the following apparatus 20 is connected to the second processing unit 22. The control unit 24 may be specifically hardware capable of computing, such as a CPU, a programmable microprocessor, a DSP, a programmable controller, an ASIC, a PLD, or another similar apparatus. The control unit 24 can receive the following steering angle information Δθ and control, according to the following steering angle information Δθ, the following apparatus 20 to steerably advance.

Specifically, because both the first direction angle information θ₁ and the second direction angle information θ₂ are direction angles relative to the North Geomagnetic Pole, the second processing unit 22 can calculate the following steering angle information Δθ according to a difference between the first direction angle information θ₁ and the second direction angle information θ₂. For example, assuming that the first direction angle information θ₁ is 50°, and the second direction angle information θ₂ is 20°, the following steering angle information Δθ is 50°−20°=30°. The control unit 24 can control the following apparatus 20 to further steer by 30° (the following steering angle information Δθ) relative to the original direction angle of 20° (the second direction angle information θ₂), so that the following apparatus 20 has a direction angle of 50°, which is the same as that of the target apparatus 10, and advances toward a direction which is the same as that of the target apparatus 10, thereby automatically following the target apparatus 10.

As shown in FIG. 1, in an embodiment, the following apparatus 20 may include a driving unit 25 connected to the control unit 24. The control unit 24 can control the driving unit 25 to drive the following apparatus 20 to steerably advance. For example, assuming that the following apparatus 20 is a vehicle, the driving unit 25 may be a structure (for example, a wheel or a redirector) driving the vehicle to steerably advance. Assuming that the following apparatus 20 is an aircraft, the driving unit 25 may be a rotor wing or a motor, and so on.

Based on the above, in the automatic following system 1 in this embodiment of the present disclosure, the geomagnetic azimuth information A of the Earth is measured by using the magnetometer, and the advancing direction angle of the target apparatus 10 is obtained according to the geomagnetic azimuth information A, so that the following apparatus 20 can calculate the following steering angle information Δθ according to the geomagnetic azimuth information A and the advancing direction angle of the target apparatus 10. In this way, the following apparatus 20 can steerably advance according to the following steering angle information Δθ and automatically follow the target apparatus 10. In addition, in this embodiment, the direction angle, measured by using the magnetometer, of the North Geomagnetic Pole is used as reference for calculating the first direction angle information θ₁ and the second direction angle information θ₂. When the direction angles are calculated according to a GPS signal, because the GPS signal is often blocked by landforms or ground objects, the accuracy is greatly reduced, and the GPS signal even cannot be used. Therefore, the automatic following system 1 in this embodiment has higher accuracy, thereby increasing the efficiency of following.

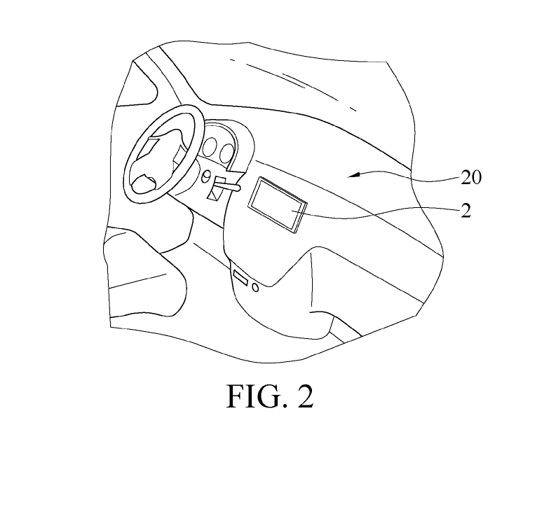

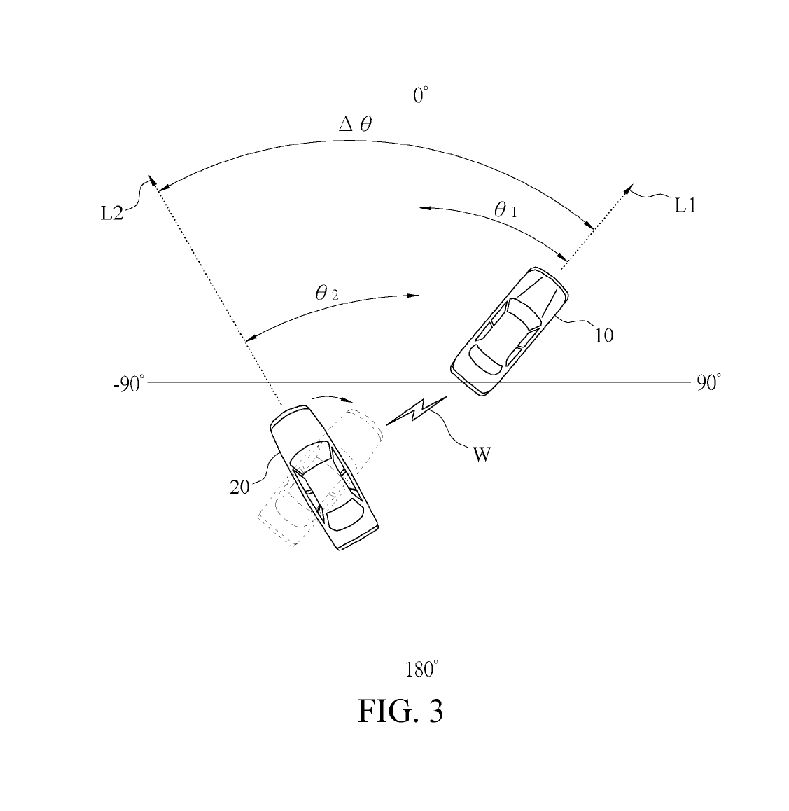

The following further specifically describes an actual application example of the automatic following system 1 with reference to drawings. As shown in FIG. 2 and FIG. 3, an example is used in which both the target apparatus 10 and the following apparatus 20 are vehicles. The second magnetometer 21, the second processing unit 22, the second wireless communications unit 23, and the control unit 24 in the following apparatus 20 may be disposed in an in-vehicle apparatus 2 (as shown in FIG. 2). The target apparatus 10 may move toward an advancing direction (for example, an arrowhead L1). The first magnetometer 11 in the target apparatus 10 can detect the geomagnetic azimuth information A (which is 0° herein). The first processing unit 12 can calculate the angle (that is, the first direction angle information θ₁, which is 40° herein) between the advancing direction of the target apparatus 10 and the North Geomagnetic Pole, and wirelessly transmit the angle to the following apparatus 20 by using the first wireless communications unit 13. The facing direction or advancing direction of the following apparatus 20 may be shown as an arrowhead L2. The second magnetometer 21 in the following apparatus 20 can also detect the geomagnetic azimuth information A (which is 0° herein). The second processing unit 22 can calculate the angle (that is, the second direction angle information θ₂, which is −30° herein) between the facing direction or advancing direction of the following apparatus 20 and the North Geomagnetic Pole. The second processing unit 22 can calculate that the following steering angle information Δθ=the first direction angle information θ₁—the second direction angle information θ₂=70°. The control unit 24 can control the following apparatus 20 to steer clockwise by 70° relative to the original direction (for example, the arrowhead L2), so that the following apparatus 20 can advance toward a direction which is the same as that of the target apparatus 10 and automatically follow the target apparatus 10.

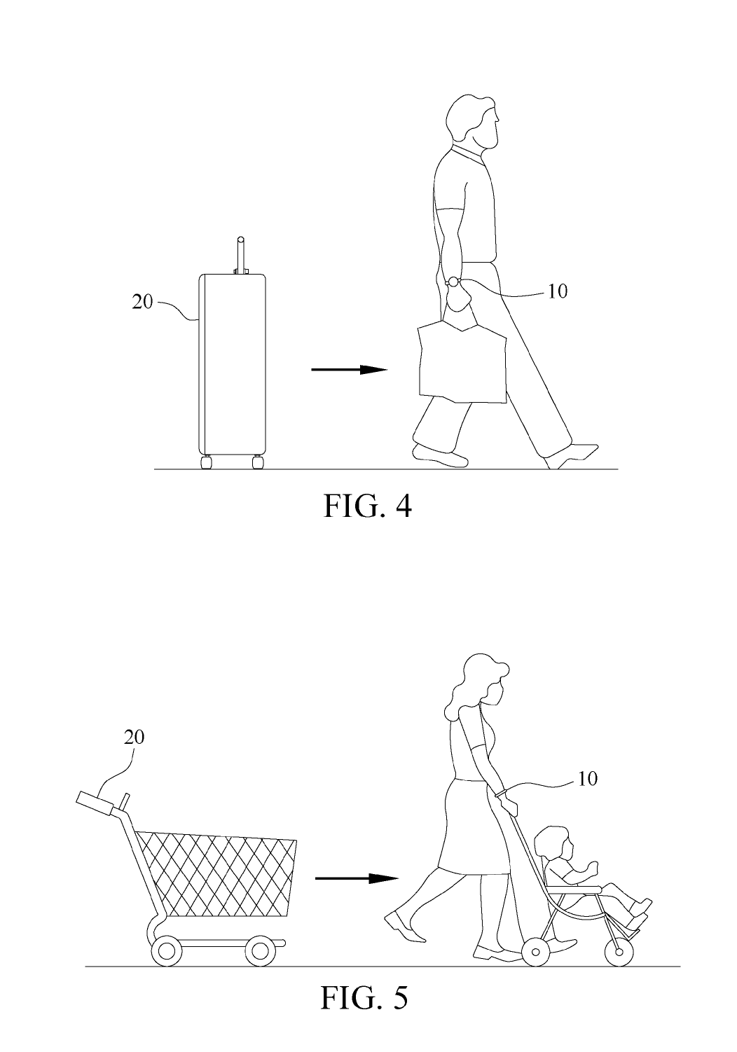

However, the foregoing embodiment is merely an example. The automatic following system 1 in the present disclosure can be applied to following other objects in addition to following vehicles. For example, as shown in FIG. 4, in this embodiment, the target apparatus 10 in the automatic following system 1 is a watch worn on the wrist of a user, and the following apparatus 20 is a suitcase. When the user is advancing, the target apparatus 10 is synchronously displaced. The suitcase can automatically follow the target apparatus 10, so that the user does not need to drag the suitcase with hands, thereby increasing convenience. Alternatively, as shown in FIG. 5, in this embodiment, the target apparatus 10 in the automatic following system 1 is a bracelet worn on the wrist of a user, and the following apparatus 20 is a cart. When the user is shopping in a store, the cart can automatically follow the target apparatus 10, so that the user does not need to push the cart with hands, thereby increasing convenience.

As shown in FIG. 1 and FIG. 3, in an embodiment, the second wireless communications unit 23 can keep detecting the wireless signal W transmitted by the target apparatus 10 and output a corresponding received signal strength indicator (RSSI). The control unit 24 controls the following apparatus 20 to increase an advancing speed of the following apparatus 20 when the RSSI keeps decreasing. Specifically, the RSSI of the wireless signal W can respond to a distance between the following apparatus 20 and the target apparatus 10. That is, a greater RSSI indicates a shorter distance between the following apparatus 20 and the target apparatus 10, and a smaller RSSI indicates a longer distance between the following apparatus 20 and the target apparatus 10. Therefore, in a process in which the following apparatus 20 follows the target apparatus 10, a smaller RSSI of the wireless signal W indicates that the advancing speed of the following apparatus 20 is inadequate, so that the control unit 24 increases the advancing speed of the following apparatus 20.

Alternatively, as shown in FIG. 1 and FIG. 3, in an embodiment, in the process in which the following apparatus 20 follows the target apparatus 10, a smaller RSSI of the wireless signal W may represent that the advancing direction of the following apparatus 20 is wrong, so that the second processing unit 22 in the following apparatus 20 re-calculates the following steering angle information Δθ, to avoid a wrong following.

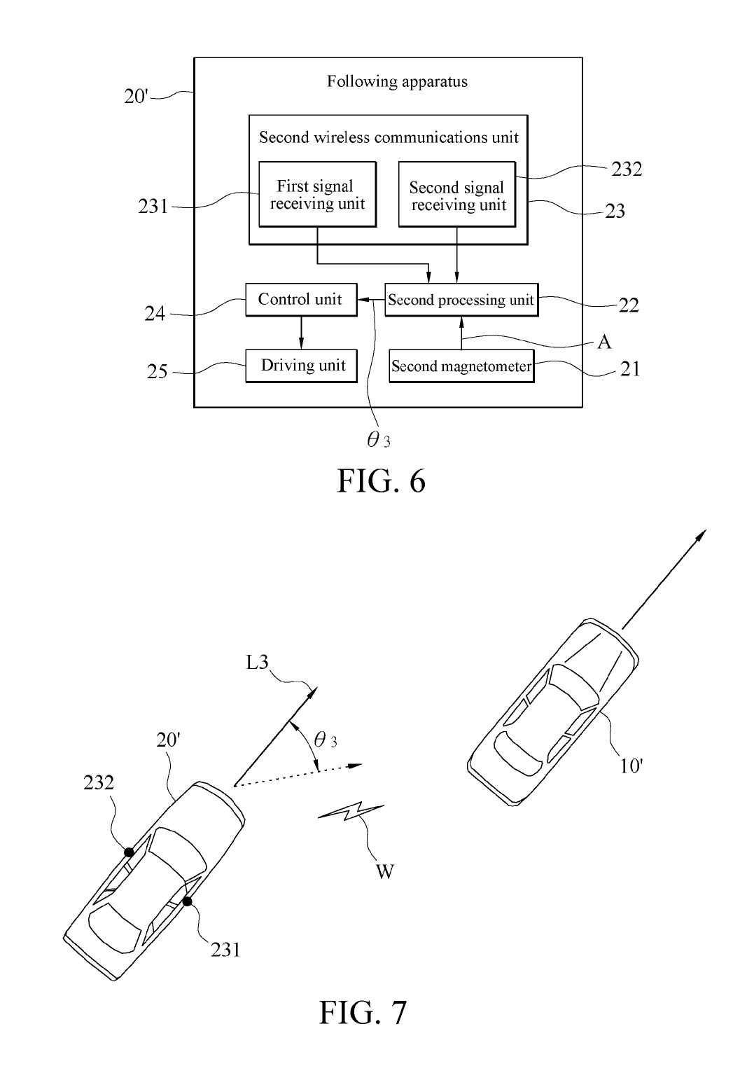

Further, referring to FIG. 6 and FIG. 7, FIG. 6 and FIG. 7 show an embodiment. This embodiment is different from the embodiment of FIG. 1 in that following apparatuses are different. A second wireless communications unit 23 in a following apparatus 20′ in this embodiment further includes a first signal receiving unit 231 and a second signal receiving unit 232. The first signal receiving unit 231 and the second signal receiving unit 232 are respectively disposed on two opposite sides (which are a right side and a left side of a vehicle) of an advancing direction (for example, shown as an arrowhead L3 in FIG. 7) of the following apparatus 20′. In a process in which the following apparatus 20′ follows a target apparatus 10′, the first signal receiving unit 231 can detect a wireless signal W and correspondingly output a first RSSI, and the second signal receiving unit 232 can detect the wireless signal W and correspondingly output a second RSSI. In the embodiment of FIG. 7, because the target apparatus 10′ is on the right of the following apparatus 20′, and the first signal receiving unit 231 is closer, than the second signal receiving unit 232, to the target apparatus 10′, the first RSSI is greater than the second RSSI. The second processing unit 22 can receive the first RSSI and the second RSSI, and learn, based on that the first RSSI is greater than the second RSSI, that the target apparatus 10′ is on the right of the following apparatus 20′, so that the second processing unit 22 generates correction angle information θ₃. The correction angle information θ₃ is a steering correction angle by which the following apparatus 20′ steers to the side of the first signal receiving unit 231. A control unit 24 can control, according to both the following steering angle information Δθ and the correction angle information θ₃, the following apparatus 20′ to steerably advance. For example, referring to FIG. 3 and FIG. 7, the following apparatus 20′ steers by 70° (the following steering angle information Δθ) before advancing toward a direction which is the same as that of the target apparatus 10′. In the process in which the following apparatus 20′ follows the target apparatus 10′, assuming that the target apparatus 10′ is on the right of the following apparatus 20′, the control unit 24 can control, according to the correction angle information θ₃, the following apparatus 20′ to steer by a rightward correction angle (the correction angle information θ₃ is 40° herein), so that the following apparatus 20′ can follow right behind the target apparatus 10′.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. An automatic following system, comprising:
a target apparatus, comprising a first magnetometer, a first processing unit, and a first wireless communications unit, wherein the first magnetometer keeps transmitting geomagnetic azimuth information, the first processing unit is connected to the first magnetometer and the first wireless communications unit, the first processing unit receives the geomagnetic azimuth information and outputs first direction angle information, the first direction angle information is an angle between a current advancing direction of the target apparatus and the Geomagnetic axis, and the first wireless communications unit transmits a wireless signal comprising the first direction angle information; and
a following apparatus, comprising a second magnetometer, a second processing unit, a second wireless communications unit, and a control unit, wherein the second magnetometer keeps transmitting the geomagnetic azimuth information, the second wireless communications unit is communicatively connected to the first wireless communications unit and receives the wireless signal, the second processing unit is connected to the second magnetometer and the second wireless communications unit, the second processing unit receives the geomagnetic azimuth information and generates second direction angle information, the second direction angle information is an angle between the following apparatus and the Geomagnetic axis, and the second processing unit calculates following steering angle information according to the first direction angle information and the second direction angle information, the control unit is connected to the second processing unit, and the control unit receives the following steering angle information and controls, according to the following steering angle information, the following apparatus to steerably advance.

2. The automatic following system according to claim 1, wherein the second wireless communications unit further keeps detecting the wireless signal and outputs a corresponding received signal strength indicator (RSSI), and the control unit controls the following apparatus to increase an advancing speed of the following apparatus when the RSSI keeps decreasing.

3. The automatic following system according to claim 1, wherein the second wireless communications unit further keeps detecting the wireless signal and outputs a corresponding RSSI, and the second processing unit re-calculates the following steering angle information when the RSSI keeps decreasing.

4. The automatic following system according to claim 1, wherein the second wireless communications unit comprises a first signal receiving unit and a second signal receiving unit, the first signal receiving unit and the second signal receiving unit are respectively disposed on two opposite sides of an advancing direction of the following apparatus, the first signal receiving unit detects the wireless signal and correspondingly outputs a first RSSI, the second signal receiving unit detects the wireless signal and correspondingly outputs a second RSSI, the first RSSI is greater than the second RSSI, the second processing unit receives the first RSSI and the second RSSI and generates correction angle information according to the first RSSI and the second RSSI, the correction angle information is a steering correction angle by which the following apparatus steers to the side of the first signal receiving unit, and the control unit controls, according to both the following steering angle information and the correction angle information, the following apparatus to steerably advance.

5. The automatic following system according to claim 1, wherein the following apparatus further comprises a driving unit connected to the control unit, and the control unit controls the driving unit to drive the following apparatus to steerably advance.

6. An automatic following apparatus, comprising:
a magnetometer, keeping transmitting geomagnetic azimuth information;
a wireless communications unit, keeping receiving an external wireless signal, wherein the external wireless signal comprises first direction angle information;
a processing unit, connected to the magnetometer and the wireless communications unit, wherein the processing unit keeps receiving the geomagnetic azimuth information and generates second direction angle information, the second direction angle information is an angle between the automatic following apparatus and the Geomagnetic axis, and the processing unit calculates following steering angle information according to the first direction angle information and the second direction angle information; and
a control unit, connected to the processing unit, wherein the control unit receives the following steering angle information and controls, according to the following steering angle information, the automatic following apparatus to steerably advance.

7. The automatic following apparatus according to claim 6, wherein the wireless communications unit further keeps detecting the external wireless signal and outputs a corresponding RSSI, and the control unit controls the automatic following apparatus to increase an advancing speed of the automatic following apparatus when the RSSI keeps decreasing.

8. The automatic following apparatus according to claim 6, wherein the wireless communications unit further keeps detecting the external wireless signal and outputs a corresponding RSSI, and the processing unit re-calculates the following steering angle information when the RSSI keeps decreasing.

9. The automatic following apparatus according to claim 6, wherein the wireless communications unit comprises a first signal receiving unit and a second signal receiving unit, the first signal receiving unit and the second signal receiving unit are respectively disposed on two opposite sides of an advancing direction of the automatic following apparatus, the first signal receiving unit detects the external wireless signal and correspondingly outputs a first RSSI, the second signal receiving unit detects the external wireless signal and correspondingly outputs a second RSSI, the first RSSI is greater than the second RSSI, the processing unit receives the first RSSI and the second RSSI and generates correction angle information according to the first RSSI and the second RSSI, the correction angle information is a steering correction angle by which the automatic following apparatus steers to the side of the first signal receiving unit, and the control unit controls, according to both the following steering angle information and the correction angle information, the automatic following apparatus to steerably advance.

10. The automatic following apparatus according to claim 6, further comprising a driving unit connected to the control unit, and the control unit controls the driving unit to drive the automatic following apparatus to steerably advance.
